(19) United States
(12) Patent Application Publication
(10) Pub. No.: US 2025/0302682 A1
(43) Pub. Date: Oct. 2, 2025

(54) Assistive Sit-to-Stand Device for Physically Impaired Individuals

(71) Applicant: Yen Ching Chu, Cupertino, CA (US)

(72) Inventor: Yen Ching Chu, Cupertino, CA (US)

(21) Appl. No.: 18/620,676

(22) Filed: Mar. 28, 2024

(51) Int. Cl. A61G 5/14; A61G 5/10

(52) U.S. Cl. CPC A61G 5/14; A61G 5/1059

(57) ABSTRACT

Apparatuses and techniques for assisting physically impaired persons to sit and stand are disclosed herein. A sit-to-stand apparatus may include a base having a front base bracket, a rear base bracket, and side base brackets, a slidable seat apparatus positioned above the base configured to slide forward and backward, a lift apparatus, and a power apparatus under the stationary seat, the power apparatus comprising at least two wrap springs and a gas spring, the power apparatus configured to release potential energy saved from a seated user to lift the seated user towards a standing position. The front base bracket, the rear base bracket, and the two side base brackets together form a rectangular structure. The base may be coupled to a chair, a bench, a wheelchair, a toilet seat, a commode, and other seat types.

### FIELD OF DISCLOSURE

The present disclosed invention relates to sit-to-stand devices to assist physically impaired individuals to perform sit-to-stand and stand-to-sit movements.

### BACKGROUND OF INVENTION

Studies have shown that elderly and physically impaired individuals cannot effectively perform the first phase of the sit-to-stand transfer movements, including leaning forward and bending their knees to reduce the torque exerted on the muscles of their lower limbs by their suspended trunk weight. While they may initially lift their hips, they often struggle to raise their suspended trunk fully, leading to a risk of falling back into the seat or off the seat. These transfer movements pose a high risk for the elderly and impaired, necessitating assistance tools to prevent slipping from the seat to the floor or otherwise hurting and injuring themselves.

Conventional sit-to-stand devices typically feature a seat, a power apparatus, a lift apparatus, and a base or chair frame. The power apparatus functions by storing potential energy discharged from the seated person and releasing this stored potential energy to facilitate the process of standing up. There are two types of lift apparatus used to connect the seat and base. The first type of the lift apparatus employs a pivot mechanism to link the seat and the base, allowing the seat to tile forward, thereby raising the user while forming a triangular structure with the seat, base, and the power apparatus. The second type of the lift apparatus comprises front and rear stanchions and four pivot mechanisms, with one end of each stanchion pivotally connected to the seat and the other end to the base. This configuration enables the seat to be raised either in parallel or at a low tilt angle to the base, resulting in the formation of a quadrilateral structure involving the seat, two stanchions, and the base.

Many known sit-to-stand devices featuring the first type of the lift apparatus utilize the power apparatus to store the potential energy from the seated person and release the potential energy to raise the seated person. In theory, the potential energy derived from the seated trunk's weight is not sufficient to lift the same seated trunk's weight up. However, in practice, a slight amount of forward trunk weight shift as the result of leaning forward trunk in the first phase of the sit-to-stand transfer movements, reduces enough downward torque to reverse the torque balance. This enables the power apparatus to raise the seat and trunk, and aid in standing up.

For example, China Patent CN2629542Y employs a wrap spring to store and release energy, complementing hand-pushing on armrest to assist in standing up. The China Patent CN108095391B, U.S. Pat. Nos. 2,598,577, 3,158,398, and 5,082,327 utilize wrap springs as storage and release energy mechanisms, facilitating seat pivoting to assist standing up. U.S. Pat. No. 3,479,087 uses an airbag storages and releases energy device to rotate the seat surface for lifting assistance. U.S. Pat. Nos. 4,538,853, 4,587,678, 4,690,457, 5,316,370, and 6,449,783 B1 employ gas spring as storage and release energy device to pivot the seat for standing. The most prevalent design in the market utilizes the gas spring for storing and releasing energy. U.S. Pat. No. 7,434,882 B1 utilizes the energy from balance weight for storage and release. U.S. Pat. No. 9,918,886 B2 utilizes pulling rear-end of the armrest to pivot the seat up. Taiwan Patent No. M645664 and China Patent CN12190056A use forward shifting trunk weight to release saved energy from wrap spring, enabling the pivot of the seat surface upward. U.S. Pat. No. 10,449,100 B2 extends an armrest to forward shift the counter weight, presses down the armrest to flip the seat forward, and shifts forward the seat to clear the exit access blocking by the extended armrest.

While the first type of conventional lift apparatus offers a straightforward solution with a tilted forward seat surface to elevate the buttocks and facilitate standing up, it should be noted that this design may lead to issues for frail patients and the elderly to sit back down. Specifically, if frail patients' or elderly individuals' trunk weight cannot overcome the power apparatus beneath the seat to press down the tilted seat, the gravity may draw their buttocks to slide along the tilted seat surface onto the ground.

Several of these disclosed devices rely on power apparatus with external energy sources, such as electric motor, used to elevate the body up from a seated to a standing position. However, these externally powered devices have inherent drawbacks, including being bulky heavy, expensive, and difficult to be moved around. For instance, U.S. Pat. No. 6,113,188 utilizes a compressed air tank to inflate an air bag, facilitating seat pivoting. U.S. Pat. No. 6,098,215 employs a motor to pull a connecting rod for seat pivoting. U.S. Pat. Nos. 6,553,585 B1, 7,021,713 B2, and 10,219,659 B1 utilize electro-hydraulic push rods to pivot the seat. U.S. Pat. Nos. 6,637,818 B2, 6,702,383 B2, and 8,740,304 B2, as well as Chinese Patent Nos. CN208573279 U and CN110013394, employ electric motor to drive lead screw for seat pivoting.

Many sit-to-stand devices also are known to employ the second type of the lift apparatus to raise the seat horizontally or nearly horizontally. This design is intended to minimize the tilt of the seat during the lifting process, to reduce the risk of elderly or disabled individuals falling down on transitioning from sit-to-stand and stand-to-sit. U.S. Pat. Nos. 1,698,344, 5,312,157, 6,360,382 B1, 6,637,818 B2, and 7,021,713 utilize a quadrilateral lift apparatus. Chinese Patents CN202198525U, CN104783722B, CN207101215, CN207613981U, along with U.S. Pat. No. 6,360,382 B1, describe the quadrilateral structure to raise the seat surface. These sit-to-stand devices employing the second type of the lift apparatus are all powered by electric motor and primarily designed for toilet seat applications. However, reliance on external energy source presents several disadvantages, including high costs, space limitation, and difficult in moving.

Therefore, an improved assistive sit-to-stand device for physically impaired individuals is desirable.

### BRIEF SUMMARY

The present disclosure provides techniques for an improved assistive sit-to-stand device for physically impaired individuals. A sit-to-stand apparatus may include: a base comprising a front base bracket, a rear base bracket, and two side base brackets, the base configured to be coupled to at least one of a chair, a bench, a wheelchair, a toilet seat, a commode, and an other seat type, where the front base bracket, the rear base bracket, and the two side base brackets together form a rectangular structure; a slidable seat apparatus positioned above the base, the slidable seat apparatus comprising a slidable seat, at least two sliding mechanisms, and a stationary seat, wherein the slidable seat is configured to slide forward and backward, the at least two sliding mechanisms arranged beneath the slidable seat; a lift apparatus configured to couple the base to the slidable seat apparatus, the lift apparatus comprising at least two sets of stanchions, each of the at least two sets of stanchions comprising a front stanchion and a rear stanchion, a first of the at least two sets of stanchions positioned toward a first side of the base and a second of the at least two sets of stanchions positioned toward a second side of the base; and a power apparatus under the stationary seat, the power apparatus comprising at least two wrap springs and a gas spring, the power apparatus configured to release potential energy saved from a seated user to lift the seated user towards a standing position. In some examples, the power apparatus is configured to transfer a trunk weight of the seated user from the stationary seat to the base. In some examples, a first end of the front stanchion and another first end of the rear stanchion are each pivotally connected to a base bracket of the stationary seat. In some examples, a second end of the front stanchion and another second end of the rear stanchion are each pivotally connected to a seat bracket of the base. In some examples, the at least two sets of stanchions, the stationary seat, and the base together form a 3D quadrilateral structure. In some examples, pivoting the lift apparatus expands and contracts the 3D quadrilateral structure, thereby raising and lowering the stationary seat.

In some examples, the base further comprises a front base flap and a rear base flap, wherein the front base flap and the rear base flap are configured to be coupled to a chair frame and/or a commode frame. In some examples, the base further comprises a front base bracket and a rear base bracket, wherein the front base bracket and the rear base bracket are configured to be coupled to a chair frame, a commode, and/or a wheelchair. In some examples, the base further comprises a front base tube and a rear base tube, one or both of the front base tube and the rear base tube comprising a quarter circle cut structure configured to couple to a wheelchair. In some examples, the base further comprises a front base tube and a rear base tube, one or both of the front base tube and the rear base tube comprising a full circle cut structure configured to fit to a tube frame, thereby integrating the sit-to-stand apparatus to a seat frame. In some examples, the base further comprises a front base flap and a rear base flap, the front base flap and the rear base flap configured to form a part of, or to be coupled to, a cushioned seat surface.

In some examples, the sliding mechanism comprises a slidable member and a stationary member. In some examples, the slidable member comprises a roller bracket, a set screw, a plurality of roller shafts and a plurality of rollers. In some examples, the roller bracket comprises a metal bracket coupled to the bottom of the seat surface. In some examples, the set screw is arranged to a side of the roller bracket and configured to stop the roller bracket from exceeding its travel limit. In some examples, each of the plurality of rollers is fixed on one of the plurality of roller shafts. In some examples, the stationary member comprises a rail guide, a rail track, and a set screw. In some examples, the rail track comprises a long flat runway for a roller to roll on. In some examples, the rail guide is configured to confine a roller to travel linearly along a length of the stationary seat. In some examples, the rail guide and rail track form at least part of a U shape channel.

In some examples, the apparatus also includes a front limit and a rear limit, each configured to provide a front travel limit and a rear travel limit, respectively, to block the slidable member from moving beyond the front and rear travel limits. In some examples, the slidable seat comprises a seat surface for supporting a user's buttocks. In some examples, the stationary seat comprises a seat framework configured to support a seated trunk weight of a user, the seat framework comprising a front seat bracket, a rear seat bracket, and two side seat brackets that together form a rectangular structure. In some examples, each of the at least two wrap springs comprises a spring coil, an up spring arm, a low spring arm, an up spring arm end, and a low spring arm end, wherein the up spring arm extends from a first end of the spring coil and the low spring arm extends from a second end of the spring coil. In some examples, the up spring arm is coupled to the stationary seat and the low spring arm is coupled to the base. In some examples, the spring coil contracts when a downward pressure is applied to the slidable seat apparatus, thereby storing energy, and the spring coil releases stored energy to push the slidable seat apparatus up. In some examples, the gas spring comprises a cylinder, a rod, a rod end, and a cylinder end, wherein the rod aligns with the cylinder coaxially to form a sealed gas chamber containing a gas. In some examples, one of the rod end and the cylinder end is pivotally connected to the base. In some examples, the gas spring is configured to provide a damping effect to prevent the slidable seat apparatus from falling onto the base with excessive force when a user sits down on the slidable seat apparatus. In some examples, the power apparatus resides under the slidable seat apparatus, each of the at least two wrap springs between an inner bracket and an outer bracket, the gas spring between two inner brackets. In some examples, the at least two wrap springs and the gas spring reside within a cavity formed by the base and the slidable seat apparatus.

### BRIEF DESCRIPTION OF THE DRAWINGS

FIG. 1 is a side view of an exemplary sit-to-stand device, in accordance with one or more embodiments.

FIG. 2 is a perspective view of an exemplary slidable seat apparatus of the sit-to-stand device in FIG. 1.

FIGS. 3A-3B are perspective views of an exemplary sliding mechanism of the slidable seat apparatus in FIG. 2.

FIG. 4 is a perspective view of an exemplary stationary seat of the slidable seat apparatus in FIG. 2.

FIG. 5a is a perspective view of an exemplary base of a sit-to-stand device, in accordance with one or more embodiments.

FIG. 5b is a perspective view of an alternative exemplary base of a sit-to-stand device, in accordance with one or more embodiments.

FIG. 5c is a perspective view of another alternative exemplary base of a sit-to-stand device, in accordance with one or more embodiments.

FIG. 5d is a perspective view of still another alternative exemplary base of a sit-to-stand device, in accordance with one or more embodiments.

FIG. 6a is a perspective view of exemplary mechanical components of a sit-to-stand device in a partially raised position, in accordance with one or more embodiments.

FIG. 6b is a perspective view of exemplary mechanical components of a sit-to-stand device in a lowered position, in accordance with one or more embodiments.

FIG. 7 is a perspective view of an exemplary wrap spring of the mechanical components shown in FIG. 6a.

FIG. 8 is a perspective view of an exemplary gas spring of the mechanical components shown in FIG. 6a.

FIG. 9a is a perspective view of an exemplary cushion on the sit-to-stand device in FIG. 1.

FIG. 9b is a perspective view of the sit-to-stand device of FIG. 1 implemented on an exemplary arm chair.

FIG. 10a is a perspective view of an exemplary sit-to-stand assist chair kit, in accordance with one or more embodiments.

FIG. 10b is a perspective view of an exemplary chair frame.

FIG. 10c is a perspective view of the sit-to-stand assist chair kit of FIG. 10a as implemented onto a chair.

FIG. 10d is a perspective view of the sit-to-stand device of FIGS. 1 and 9a implemented on the chair frame in FIG. 10b.

FIG. 11a is a perspective view of an exemplary sit-to-stand assist kit for a commode, in accordance with one or more embodiments.

FIG. 11b is a perspective view of an exemplary commode frame.

FIG. 11c is a perspective view of the sit-to-stand assist kit for commode of FIG. 11a implemented on the commode frame of FIG. 11b.

FIG. 11d is a perspective view of the sit-to-stand device of FIG. 1 implemented on the commode frame of FIG. 11b.

FIG. 12a is a perspective view of an exemplary sit-to-stand assist kit for a wheelchair, in accordance with one or more embodiments.

FIG. 12b is a perspective view of an exemplary tube base implemented on a wheelchair frame, in accordance with one or more embodiments.

FIG. 12c is a perspective view of the sit-to-stand assist kit for a wheelchair of FIG. 12a implemented on the wheelchair frame of FIG. 12b.

FIG. 12d is a perspective view of an exemplary sit-to-stand device implemented on the wheelchair frame of FIG. 12b.

FIG. 13 is a series diagram illustrating phases of movement from sitting to standing.

FIG. 14 is a series diagram illustrating body suspension moment as a function of a degree of torso leaning and a degree of knee bending.

The figures depict various example embodiments of the present disclosure for purposes of illustration only. One of ordinary skill in the art will readily recognize from the following discussion that other example embodiments based on alternative structures and methods may be implemented without departing from the principles of this disclosure, and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The disclosed sit-to-stand device allows elderly and impaired individuals to easily slide forward on the slidable seat apparatus, reducing the distance between the center of gravity of a trunk (e.g., torso, upper body, etc.) of a seated user and the soles of their feet, thereby effectively decreasing the torque exerted by the suspended trunk weight. The disclosed sit-to-stand device comprises a slidable seat apparatus, a power apparatus, a lift apparatus and a base or chair frame. The power apparatus and lift apparatus may be between the slidable seat apparatus and base, with the lift apparatus' pivot connected to the slidable seat apparatus and base. The power apparatus stores the potential energy from the trunk weight of the seated individual and releases it to raise the slidable seat apparatus. Forward sliding (e.g., of a seated user) on the slidable seat apparatus alters the torque balance, the torque balance between the downward torque of the seated trunk's weight (e.g., of a seated user's trunk) on the seat and the upward torque of the power apparatus' expanding thrust under the seat. When the upward torque from the power apparatus surpasses the downward torque from the trunk weight, the upward torque pushes the seat upward, facilitating the process of the standing up.

The disclosed invention relates to a sit-to-stand device, more specifically, a device that can be used with a broad range of chairs and chair-link apparatuses for assisting a user performing sit-to-stand and stand-to-sit movements. In order to make the technical solutions and advantages of the disclosed invention easier to be understood, the disclosed invention will be further described in detail with reference to the accompanying illustration drawings. The disclosed invention is not intended to be limited to the embodiments disclosed, but is to be accorded the widest scope consistent with the principles and novel features disclosed herein.

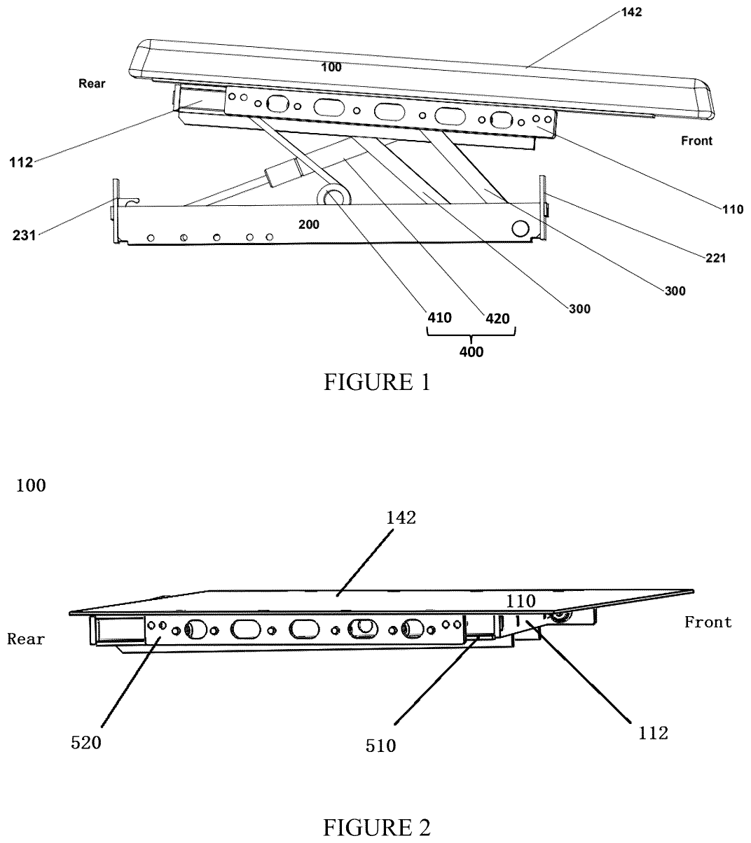

As shown in FIG. 1-14, the disclosed sit-to-stand device can be integrated with seat cushions, chairs, benches, toilet seats, commode chairs, wheelchairs, sofa chairs, car seats, etc., to help individuals stand up from a seated position, and also to help them return to a seated position from a standing position.

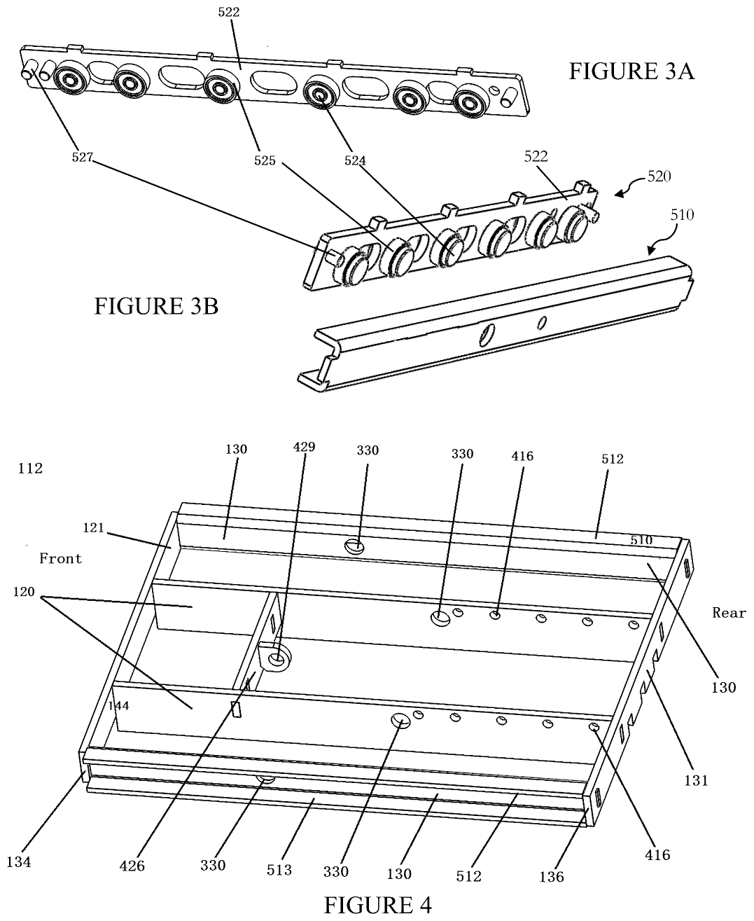

FIG. 1 is a side view of an exemplary sit-to-stand device, in accordance with one or more embodiments. FIG. 2 is a perspective view of an exemplary slidable seat apparatus of the sit-to-stand device in FIG. 1. FIG. 3 is a perspective view of an exemplary sliding mechanism of the slidable seat apparatus in FIG. 2. FIG. 4 is a perspective view of an exemplary stationary seat of the slidable seat apparatus in FIG. 2.

As shown in FIG. 1, the disclosed sit-to-stand device comprises a base 200, a slidable seat apparatus 100 positioned above the base 200, and a lift apparatus 300 pivotally coupled to the slidable seat apparatus 100 on one end and the base 200 on another end, thereby connecting slidable seat apparatus 100 to base 200. In some examples, lift apparatus 300 may comprise front stanchion 310 and rear stanchion 320. Lift apparatus 300, slidable seat apparatus 100, and base 200 together form a 3D quadrilateral structure. In some examples, slidable seat apparatus 100 may comprise slidable seat 110, sliding mechanisms 140, and stationary seat 112. The sliding mechanism 140 may comprise a slidable member 520 and a stationary member 510. In some examples, base 200 may comprise base brackets 231 and 221. In some examples, a power apparatus 400 may be positioned between slidable seat apparatus 100 and base 200. In some examples, slidable seat 110 may be configured to slide forward and backward, two or more sliding mechanisms 140 being arranged beneath slidable seat 110.

As shown in FIGS. 1-3B, the slidable seat 110 may comprise seat surface 142. In some examples, two or more slidable members 520 may be positioned parallel to each other beneath the seat surface 142. Each slidable member 520 may be paired with a stationary member 510, also positioned beneath seat surface 142. The seat surface 142 may comprise sheet metal board (e.g., 2 mm thick, or more or less depending on implementation) or other material able to carry and otherwise support the seated, semi-seated, and semi-standing weight of a user (i.e., at an area of contact, such as the buttocks). The slidable member 520 may comprise a roller bracket 522, a plurality of rollers 525 (e.g., 5, as shown, but can be more or less, as long as the number is sufficient to achieve a sliding action between slidable seat 110 and stationary seat 112, as described herein), and roller shafts 524. The roller bracket 522 may comprise a metal bracket (e.g., 3 mm thick, or may be more or less depending on implementation) welded onto the bottom of the seat surface 142 along roller bracket 522's length. A first end of the roller shaft 524 may be pressed, or otherwise fitted, to a center hole of the roller 525, and the second end of the roller shaft 524 may be welded in-line on the side of the roller bracket 522.

As shown in FIGS. 2 and 4, the stationary seat 112 may comprise a seat framework 144. The seat framework 144 may comprise a rectangular framework formed of metal brackets (e.g., 3 mm thick, or more or less depending on implementation) and configured to bear a downward seated trunk weight of a user, as well as an upward lifting thrust. The seat framework 144 may comprise a front seat bracket 121, a rear seat bracket 131, two paralleled side seat brackets 130, and two paralleled inner seat brackets 120. The side seat brackets 130 may be coupled (e.g., welded, affixed, secured) to the front seat bracket 121 and rear seat bracket 131 to form a larger rectangular framework. The front seat bracket 121, the rear seat bracket 131, and the side seat brackets 130 may comprise the 4 sides of the rectangular framework. The inner seat brackets 120 may be welded to the front seat bracket 121 and rear seat bracket 131 to form a smaller rectangular framework in between the side seat brackets 130. The distance between the left side seat bracket 130 and the left inner seat bracket 120 may be the same as the distance between the right side seat bracket 130 and the right inner seat bracket 120. Alternatively, the seat framework 144 may be manufactured in a plastic injection or die casting aluminum process in one piece.

In addition, the side seat bracket 130 may comprise a U shape channel bracket. The U shape may open outward. The stationary member 510 may be part of the U shape side seat bracket 130 and may comprise a rail guide 512 and a track (i.e., rail track) 513. In some examples, track 513 may comprise a long flat runway for a roller to roll on. In some examples, rail guide 512 may be configured to confine a roller to travel linearly along a length of the stationary seat. The rail guide 512 may be a top side of the U shape channel and configured to keep the rollers 525 in the U shape channel. The track 513 may be the low side of the U shape channel and configured to provide the runway for the roller 525.

The rectangular seat framework 144 also may comprise a front limit 134 and rear limit 136. The rear limit 136 may block, fully or mostly, a rear end of the U shape side seat bracket 130 to set a rear travel limit for the roller 525. The front limit 134 may block, at least partially, the front end of the U shape side seat bracket 130 to allow the rollers 525 to insert into the U channel. As shown in FIG. 3, the slidable member 520 also may comprise a set screw 527 on the roller bracket 522 (e.g., the set screw 527 arranged to a side of the roller bracket 522 to stop roller bracket 522 from exceeding its travel limit). In some examples, the set screw 527 may be removed to provide the required clearance for inserting the slidable member 520 into the stationary member 510 to assemble the sliding mechanism.

The combination of the U shape side seat bracket 130, the front limit 134, the rear limit 136, and the set screw 527 may achieve the slidable member 520 coupling with the stationary member 510. The slidable member 520 and the stationary member 510 make up the sliding mechanism 140.

It can be understood that there are various coupling and sliding methods for making the sliding mechanism 140. For example, the slidable member 520 may slide on a polished frictionless flat surface on the rectangular seat framework 144, or on the topside of the stationary seat 112. The rollers 525 can be seated on a flat surface on the topside of the stationary seat 112 for a slidable seat to slide on (e.g., in both forward, or front, and backward, or rear, directions).

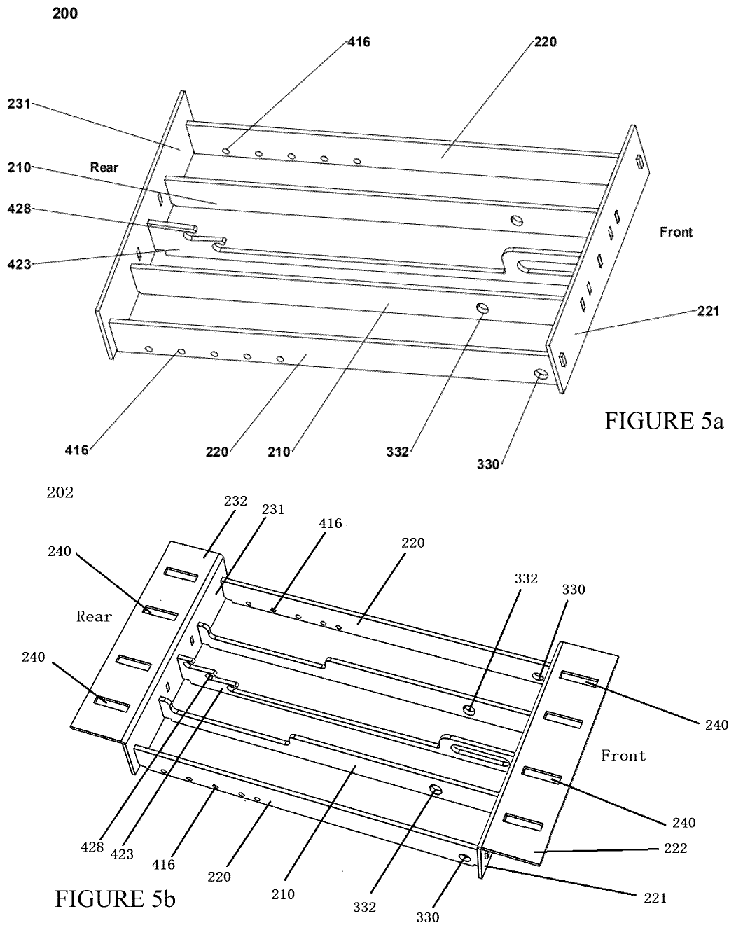

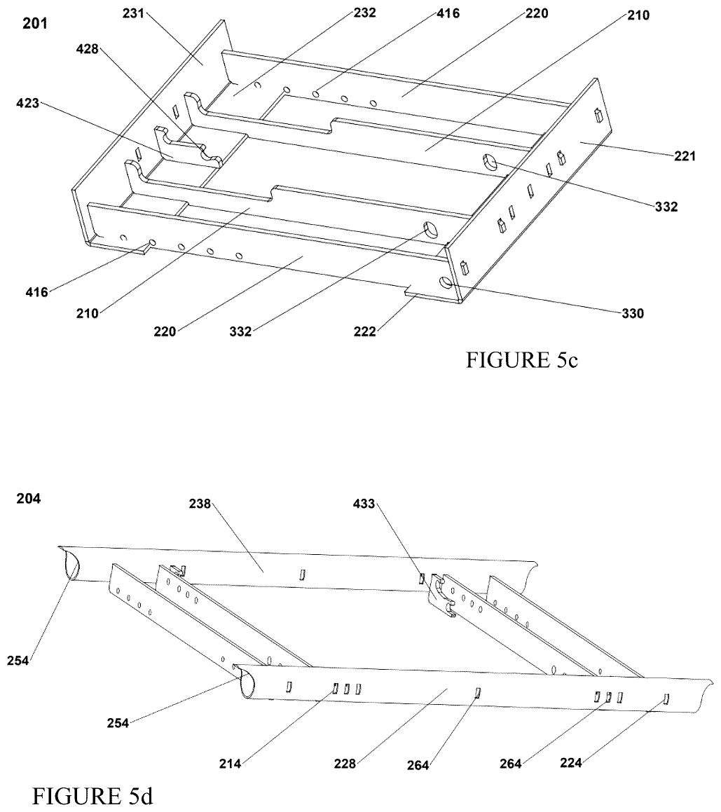

FIG. 5a is a perspective view of an exemplary base of a sit-to-stand device, in accordance with one or more embodiments. As shown in FIG. 5a, the base 200 may be a rectangular framework and may be made of a metal bracket (e.g., 3 mm thick, or may be more or less depending on implementation) to bear the trunk weight of a seated user, may comprise a front base bracket 221, a rear base bracket 231, two paralleled side base brackets 220, and two paralleled inner base brackets 210. The two side base brackets 220 may be welded to the front base bracket 221 and rear base bracket 231 to form a larger rectangular framework. The front base bracket 221, the rear base bracket 231, and two side base brackets 220 may comprise the 4 sides of the rectangular framework. The two inner base brackets 210 may be welded to the front base bracket 221 and rear base bracket 231 to form a smaller rectangular framework in between two side base brackets 220. In some examples, the distance between the left side base brackets 220 to the left inner base bracket 210 may be the same as the distance between the right side base brackets 220 to the right inner base bracket 210. Alternatively, the base 200 can be manufactured in a plastic injection or die casting aluminum process in one piece.

FIG. 5b is a perspective view of an alternative exemplary base of a sit-to-stand, in accordance with one or more embodiments. As shown in FIG. 5b, outward flap base 202 may be a variation of the base 200 configured to be implemented on a chair, a commode, and other similar seating structure. Base 202 may comprise a front base flap 222 and a rear base flap 232, wherein the front base flap 222 extends outward from the top edge of the front base bracket 221 to form an integrated L or Γ shape front bracket with outward flap, and the rear base flap 232 extends outward from the top edge of the rear base bracket 231 to form an integrated L or Γ shape rear bracket with outward flap. The front and rear base flaps can be coupled (e.g., placed, mounted, fixed, secured, connected) on the front and rear seat frames of a chair or on the front and rear seat tubes of a commode. The front and rear brackets may be press formed and welded to the side base bracket 220 to form a rectangular seat framework 144 with the flaps pointing outward.

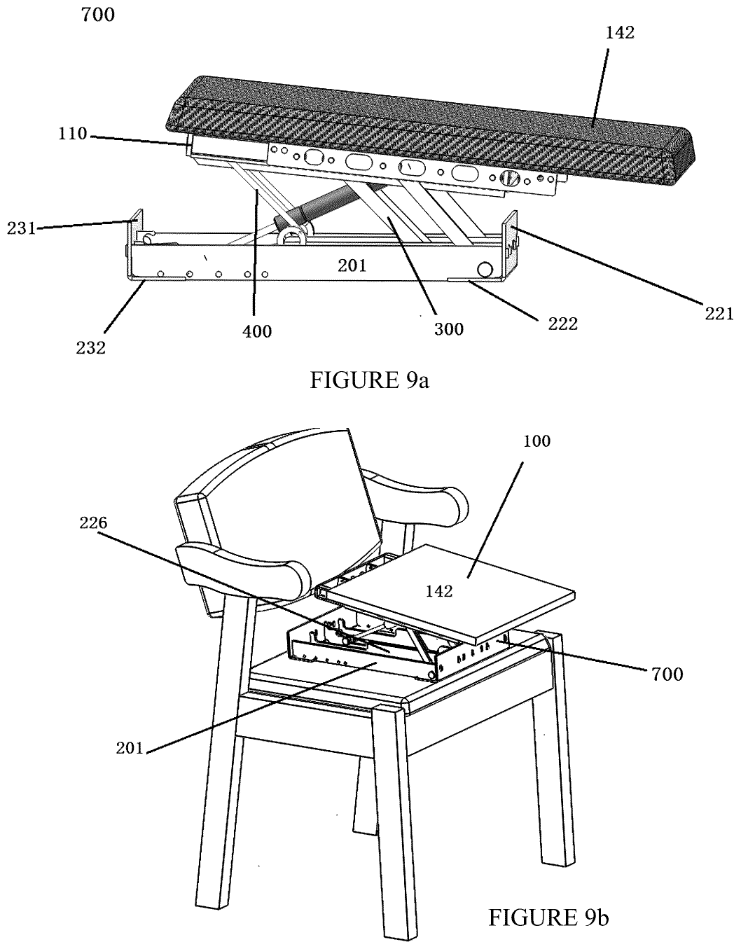

FIG. 5c is a perspective view of another alternative exemplary base of a sit-to-stand device, in accordance with one or more embodiments. As shown in 5c, the inward flap base 201 may be a variation of base 200 implemented with a cushion. In some examples, inward flap base 201 may comprise a front base flap 222 and a rear base flap 232, wherein the front base flap 222 may extend inward from the bottom edge of the front base bracket 221 to form an integrated L or Γ shape front base bracket with an outward flap, and the rear base flap 232 may extend inward from the bottom edge of the rear base bracket 231 to form an integrated L or Γ shape rear base bracket with inward flap. The front base flap 222 and the rear base flap 232 may form a flat surface in the bottom of the base and may be configured to spread a seated weight across some or all of a seat surface of a chair, a seat, a bench, or other flat surface. The front and rear base brackets may be press formed and welded to the inner base brackets 210 and side base bracket 220 to form the rectangular seat framework 144 with the flaps pointing inward. In some examples, one or both of front base flap 222 and rear base flap 232 may be coupled to or form a portion of a cushion seat (e.g., cushion seat 700 comprising cushioned seat surface 142 in FIGS. 9a-9b).

FIG. 5d is a perspective view of still another alternative exemplary base of a sit-to-stand device, in accordance with one or more embodiments. As shown in FIG. 5d, tube base 204 may be a variation on base 200 and may comprise a front base tube 228 and a rear base tube 238 (e.g., instead of the front base bracket 221 and rear base bracket 231). In some examples, one or both ends of the front base tube 228 and the rear base tube 238 may be cut into a quarter circle curve, thereby forming quarter circle cut tube end 254, for quick coupling (e.g., mounting, setting onto, placing on, resting on, removably or fixedly) on the side seat tubes of a wheelchair. In other examples, front base tube 228 and/or rear base tube 238 may comprise a full circle cut structure configured to fit to a tube frame, thereby integrating the sit-to-stand device to a seat frame (e.g., of a wheelchair, commode, and other types of chair or seat). In still other examples, tube base 204 may be coupled to a wheelchair using other methods. The outer base holes 224, inner base holes 214, and rod base holes 264 may be punched onto the front base tube 228 and the rear base tube 238, for example, to couple (e.g., affix, mount, etc.) the side base brackets 220, inner base brackets 210, and rod brackets 423. The front base tube 228 and rear base tube 238 may be welded to the inner base brackets 210 and side base bracket 220 to form the rectangular seat framework 144.

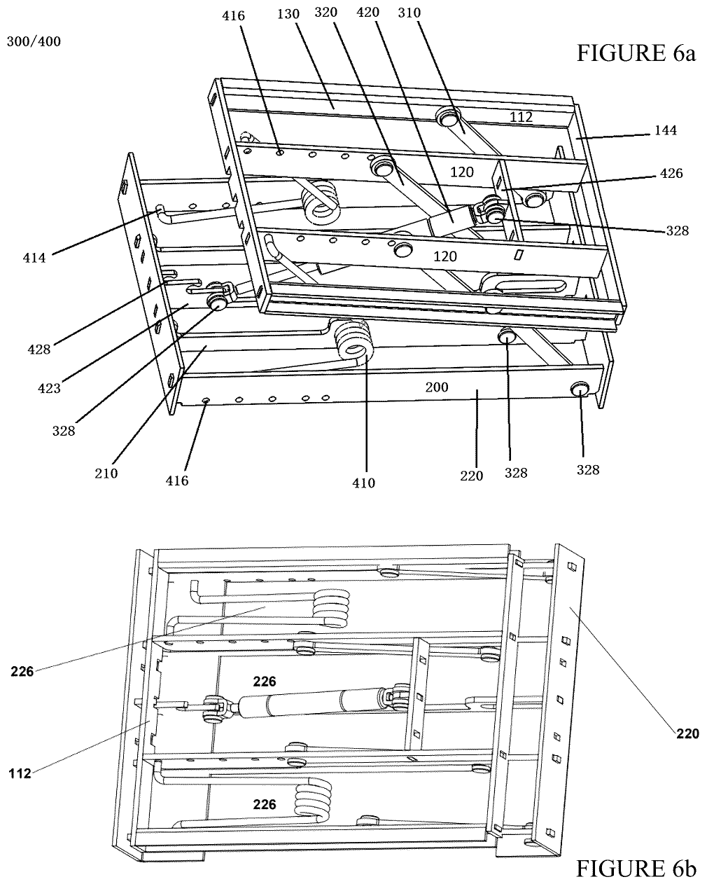

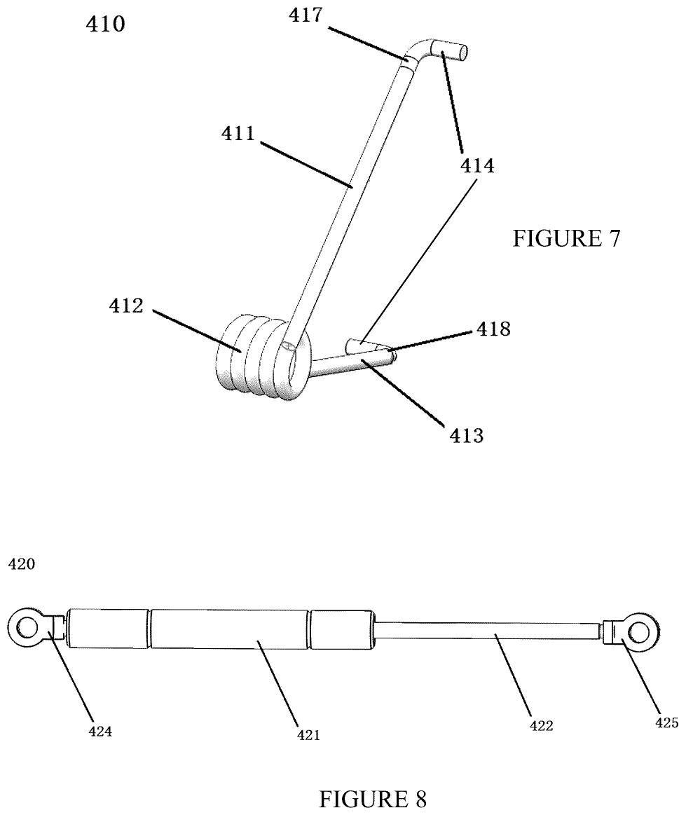

FIG. 6a is a perspective view of exemplary mechanical components of a sit-to-stand device in a partially raised position, in accordance with one or more embodiments. FIG. 6b is a perspective view of exemplary mechanical components of a sit-to-stand device in a lowered position, in accordance with one or more embodiments. FIG. 7 is a perspective view of an exemplary wrap spring of the mechanical components shown in FIG. 6a. As shown in at least FIGS. 1, 5a and 6a, the lift apparatus 300 may comprise two each of front stanchion 310 and rear stanchion 320. A first stanchion set (e.g., one each of front stanchion 310 and rear stanchion 320) may be on one side (e.g., a left side) of the base 200, and a second stanchion set may be on another side (e.g., a right side) of the base 200. The rear stanchion 320 may be behind front stanchion 310. A first end of front stanchion 310 may be pivotally connected to side base bracket 220 with a pivot shaft 328 and shaft hole 330, a first end of the rear stanchion 320 being pivotally connected to inner base bracket 210 with another pivot shaft 328 and another shaft hole 330. A second end of the front stanchion 310 may be pivotally connected to side seat bracket 130, and a second end of the rear stanchion 320 may be pivotally connected to inner seat bracket 120, with another set of pivot shafts 328 and shaft holes 330.

The front stanchions 310, rear stanchions 320, base 200, and seat framework 144 may form a 3D quadrilateral structure. It can be understood that when the front stanchions 310 and rear stanchions 320 pivot forward, the quadrilateral structure unfolds and raises the slidable seat apparatus 100, whereas when the front stanchion 310 and rear stanchion 320 pivot backward, the quadrilateral structure folds and lowers the slidable seat apparatus 100. As shown in FIG. 6b, the folded 3D quadrilateral structure forms a cavity 226 within the sit-to-stand device comprising seat 112 and base 200 (e.g., approximately 5.5-6.5 cm in height, maybe more or less depending on heights of the varying embodiments of seat 112 and base 200).

In some examples, the front stanchions 310 and rear stanchions 320 may comprise low carbon steel brackets (e.g., approximately 4 mm thick, or thicker or thinner, depending on implementation). The front stanchion 310 may be arranged to keep the side seat bracket 130 and side base bracket 220 in one vertical plane. The rear stanchion 320 may be arranged to keep the inner seat bracket 120 and inner base bracket 210 in one vertical plane. To keep the two front stanchions 310 parallel, the shaft holes 330 for the side base brackets 220 connecting to the front stanchions 310 both may be an equal distance to the front base bracket 221, and similarly the shaft holes 330 for the side seat brackets 130 connecting to the front stanchions 310 both also may be an equal distance to the front seat bracket 121. To keep the two rear stanchions 320 parallel, the shaft holes 330 for the inner base brackets 210 connecting to the rear stanchions 320 both may be an equal distance to the front base bracket 221, and similarly the shaft holes 330 for the inner seat brackets 120 connecting to the front stanchions 310 both may be an equal distance to the front seat bracket 121. It can be understood that the rectangular seat framework 144 can be raised from the base 200, during which the front base bracket 221 and the rear base bracket 231 may remain parallel to the front seat bracket 121 and rear seat bracket 131, respectively.

FIG. 6a also shows power apparatus 400. Those skilled in the art will understand that there are many implementation methods for the power apparatus 400 to store a trunk weight of a seated user's potential energy and to release stored potential energy to assist in standing up. As shown in FIG. 6a, this embodiment discloses a power apparatus 400 comprising two wrap springs 410, each between an inner bracket and an outer bracket. Power apparatus 400 also comprises a gas spring 420 in between two inner brackets (e.g., also between the two wrap springs 410). The wrap springs 410 and gas spring 420 may be compressed in cavity 226, within the stationary seat 112 and the base 200, as shown in FIG. 6b.

As shown in FIGS. 1 and 6a, a first end of the power apparatus 400 may be pivotally connected to an underside of the stationary seat 112, a second end of the power apparatus 400 may be pivotally connected to a topside of the base 200. Upon sitting down, a user's seated buttock's weight may press the stationary seat 112 down to close the 3D quadrilateral structure, thereby contracting the power apparatus 400 to store energy. Upon standing up, the power apparatus 400 may release the stored energy to expand the 3D quadrilateral structure, wherein the stationary seat 112 may rise to push the seated buttocks up.

The wrap spring 410, as shown in detail in FIG. 7, may be made of stainless steel for better rust resistance. In some examples, wrap spring 410 may comprise a spring coil 412, an up spring arm 411 extended from a first end of the spring coil 412, a low spring arm 413 extended from a second end of the spring coil 412, a low spring arm end 418, and an up spring arm end 417. In addition, a spring hook 414 may be bent on the low spring arm end 418 and the up spring arm end 417. As shown in FIGS. 4-5c, five spring holes 416 may be created (e.g., punched, bored, drilled) in-line on the inner seat bracket 120, and five spring holes 416 may be created in-line on the side base bracket 220.

As shown in FIG. 6a, the spring hook 414 of the up spring arm 411 may be inserted into one of the spring holes 416 on the inner seat bracket 120, and the spring hook 414 of the low spring arm end 418 may be inserted into one of the spring holes 416 on the side base bracket 220. Five spring holes are used to adjust the wrap spring's upward thrust torque, which is the function of the distance from the up spring end 417 to the shaft hole 330 on the side base bracket 220.

When a user is seated thereby applying a downward pressure on slidable seat apparatus (e.g., slidable seat apparatus 100), the spring coil 412 contracts and stores energy. At the beginning of a standing up motion or action, the compressed wrap spring 410 in the cavity 226 reserves the most expanding thrust energy, the expanding thrust angle being approximately 85 degree to the stationary seat 112, wherein the sinusoidal value of 85 degrees is approximately 0.996, providing the greatest amount of effective upward thrust. As the wrap spring 410 expands, the expanding thrust decreases along with the thrust angle to the stationary seat; the sinusoidal value similarly decreases, as does the upward thrust. The expanding thrust nears or reaches zero when the wrap spring 410 is fully expanded. The advantage of the wrap spring 410 is to provide the peak upward lifting thrust when the seated individual needs the up thrust the most.

Those skilled in the art will understand there are many means to implement the wrap spring to store and release energy to assist standing up. The embodiments described herein utilizing a pair of single wrap springs is only one example solution. For example, a dual wrap spring can be used for heavier duty applications.

FIG. 8 is a perspective view of an exemplary gas spring of the mechanical components shown in FIG. 6a. As shown, the gas spring 420 may provide a damping effect to prevent a slidable seat apparatus (e.g., slidable seat apparatus 100) from falling onto a base (e.g., base 200, base 201, base 202, base 204, etc.) with excessive force when a user sits down on the slidable seat apparatus (e.g., to protect a user from falling onto the seat). In some examples, gas spring 420 may comprise a metal cylinder 421 with a sealed gas chamber, a steel rod 422 with a piston fixed in the cylinder, a cylinder end 424, and a rod end 425. The rod 422 can shorten and extend to compress and decompress the gas in the gas chamber. As shown in FIGS. 4 and 6a, a cylinder bracket 426 with a cylinder hole 429 may be welded on the seat framework 144 between two inner seat brackets 120. A rod bracket 423 with a plurality of mounting slots 428 may be welded on the rear base bracket 231. As shown in FIG. 6a, the cylinder end 424 may be pivotally connected to the cylinder bracket 426 on the cylinder hole 429 with the pivot shaft 328, and the rod end 425 may be pivotally connected to one of the mounting slot 428 on the rod bracket 423 with the pivot shaft 328. In this example, three in-line mounting slots 428 may be used to adjust the lifting height of the sit-to-stand device.

One of the differences between the gas spring and the wrap spring is the expanding thrust of the fully expanded and relaxed wrap spring is zero or very nearly zero, whereas the expanding thrust of the fully expanded and relaxed gas spring is the preload thrust (e.g., not zero). The preload thrust of the gas spring is set in the factory according the specifications for said gas spring (e.g., approximately 80% of the thrust of a fully compressed gas spring).

At the beginning of standing up, the gas spring 420 in the cavity 226 reserves the most extending thrust energy. However, the extending thrust angle of the gas spring 420 in the cavity 226 may be about 5 degrees to the seat framework 144, wherein the sinusoidal value of the extending thrust angle is approximately 0.087, at which point the least amount of useful upward thrust is provided. When the gas spring 420 is fully extended, the extend thrust is at its preload thrust, the sinusoidal value of the extending thrust angle is at its highest value, and the upward thrust is close to its peak value. The advantage of the gas spring 420 is to provide the damping needed to slow down falling speed to protect a user from falling onto the seat too quickly.

As shown in FIGS. 1 and 6a-6b, the power apparatus 400 of this embodiment combines both gas spring 420 and wrap spring 410 to optimize the overall lifting performance. At the beginning of a standing up action, the wrap spring 410 provides more of the upward lifting thrust. As the stationary seat 112 rises, the gas spring 420 increases the contribution to the upward lifting thrust to assist standing up till the end. The fully extended gas spring 420 slows down the falling speed of the sitting trunk and prevents falling.

As shown in FIGS. 4-6b, a shaft hole 332 on the inner base bracket 210 connecting the rear stanchion 320 may be enlarged to provide the excessive clearance to the pivot shaft 328. The pivot shaft 328 may float in the enlarged shaft hole 332 when the power apparatus 400 raises the stationary seat 112, wherein the trunk weight of a seated user is transferred from the stationary seat 112 to the base 200 through the power apparatus 400 directly, bypassing the rear stanchion 320. The power apparatus 400 becomes the rear bar in the four-bar linkage structure of the 3D quadrilateral structure.

FIG. 9a is a perspective view of an exemplary cushion on the sit-to-stand device in FIG. 1. FIG. 9b is a perspective view of the sit-to-stand device of FIG. 1 implemented on an exemplary arm chair. As shown in FIG. 9a, a first application of the disclosed sit-to-stand device is a portable sit-to-stand assist cushion 700. This portable sit-to-stand assist cushion 700 comprises an inward flap base 201, the slidable seat apparatus 100, the lift apparatus 300, and the power apparatus 400. The seat surface 142 may comprise a board structure covered with a soft material for the comfort of user. As shown in FIGS. 5c and 9b, an inward facing front base flap 222 and rear base flap 232 in the bottom of the sit-to-stand assist cushion 700 may form a flat surface structure to spread a seated weight on a chair seat or other flat surface. It is preferable to minimize thickness of the seat cushion to keep the seat height within the comfort zone of the seated individual. A latch can be used to lock the sit-to-stand assist cushion 700 in a closed position.

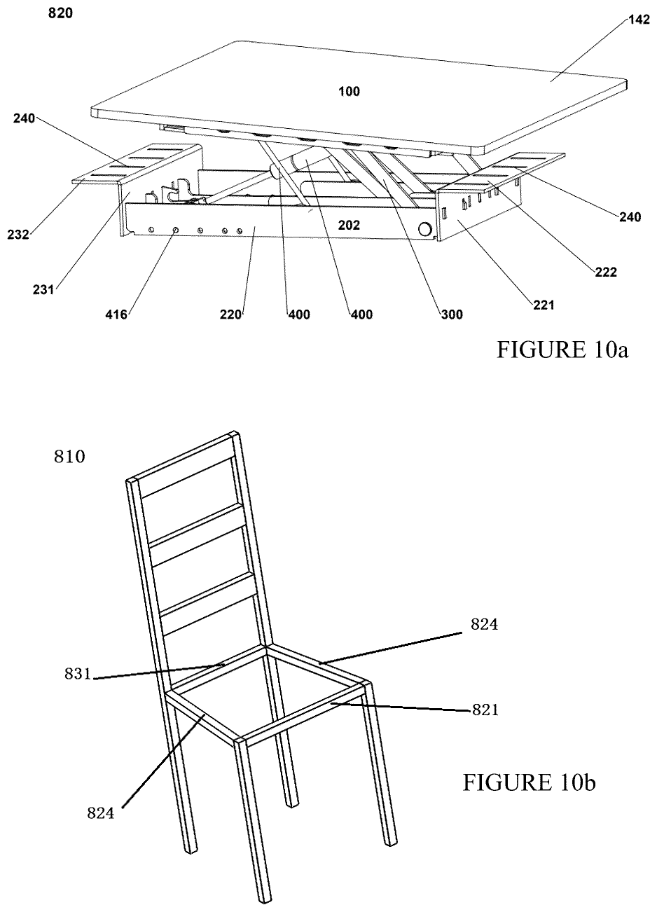

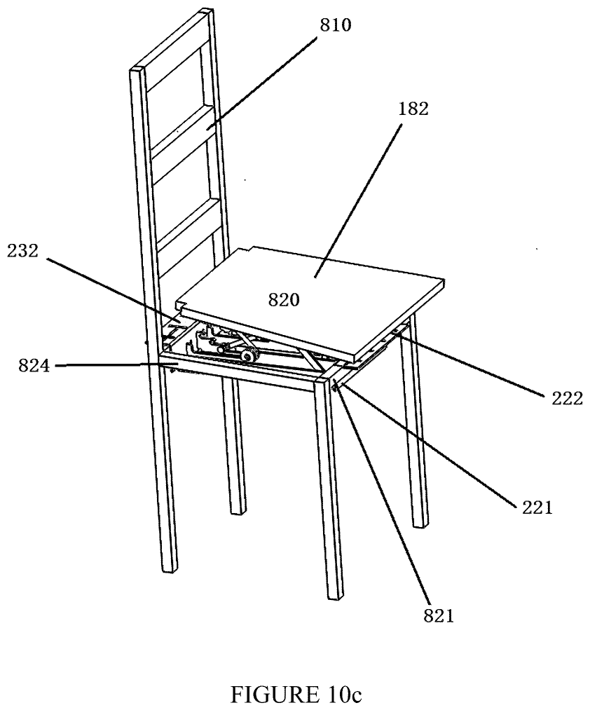

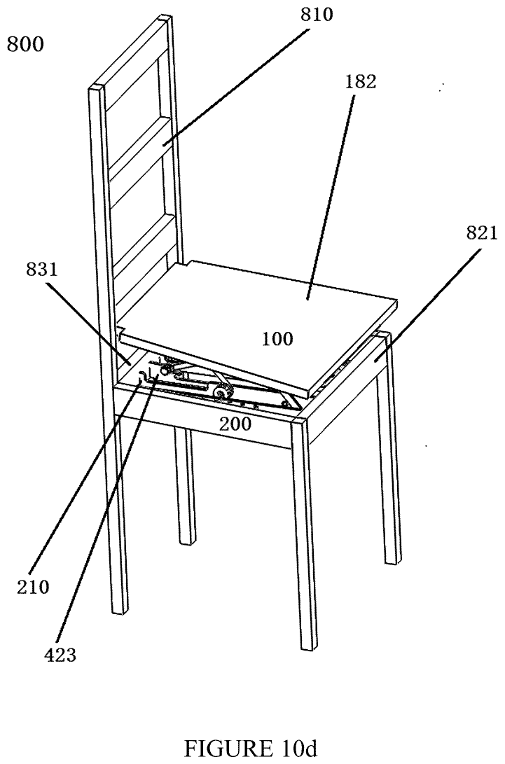

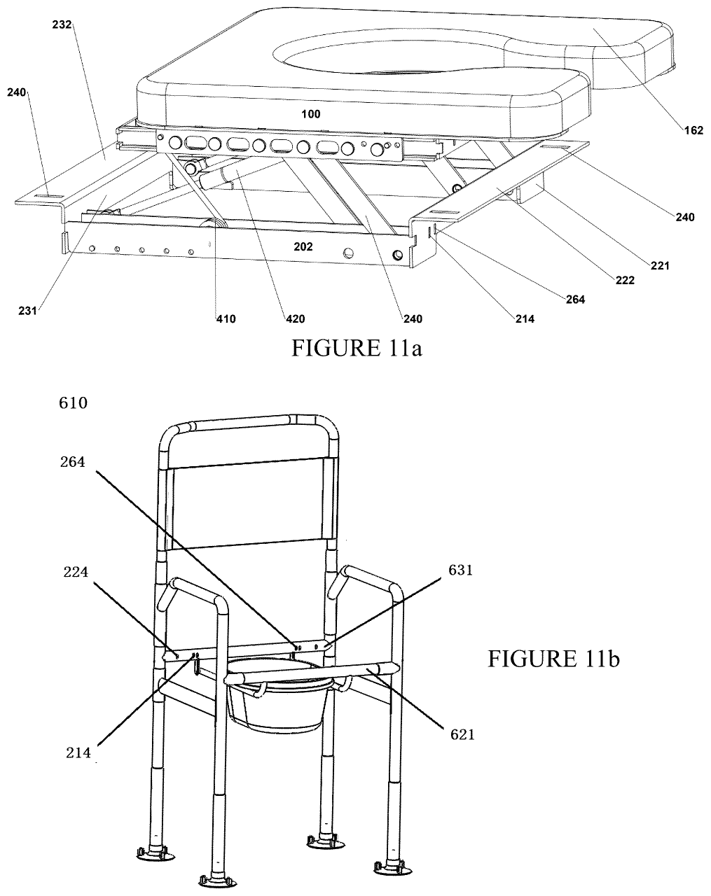

FIG. 10a is a perspective view of an exemplary sit-to-stand assist chair kit, in accordance with one or more embodiments. FIG. 10b is a perspective view of an exemplary chair frame. FIG. 10c is a perspective view of the sit-to-stand assist chair kit of FIG. 10a as implemented onto a chair. FIG. 10d is a perspective view of the sit-to-stand device of FIGS. 1 and 9a implemented on the chair frame in FIG. 10b. As shown in FIGS. 10a-10b and 10d, a second application of the sit-to-stand device is a sit-to-stand assist chair 800. The sit-to-stand assist chair 800 comprises a chair framework 810, a base 200, the slidable seat apparatus 100, the lift apparatus 300, and the power apparatus 400. In some examples, the side base brackets 220, inner base brackets 210, and rod bracket 423 of the base 200 may be coupled (e.g., placed, fixed, connected, mounted, secured) directly to the rear seat frame 831 and front seat frame 821 of the chair framework 810. The front base bracket 221 and rear base bracket 231 may be integrated to the chair framework 810, wherein the sit-to-stand device is an integral part of the chair. In other examples, base 200 and slidable seat apparatus 100 may be removably coupled to chair framework 810, for example, for a portable or otherwise replaceable implementation (see e.g., chair kit 820).

As shown in FIGS. 5c and 10a-10c, a chair can be upgraded to a sit-to-stand assist chair 800 by a sit-to-stand assist chair kit 820, which comprises the outward flap base 202, the slidable seat apparatus 100, the lift apparatus 300, and the power apparatus 400. The front base flap 222 and rear base flap 232 may be coupled (e.g., mounted, placed, secured, fixed, connected) onto the front seat frame 821 and rear seat frame 831 to convert a chair into a sit-to-stand assist chair 800 with the chair kit 820. The punched flap slots 240 on the front base flap 222 and the rear base flap 232 may be used to secure the outward flap base 202 to the chair framework. The original chair seat surface 182 on the chair can be used as the seat surface of the sit-to-stand assist kit for chair 820. A latch can be used to lock the kit for chair 820 in a closed position.

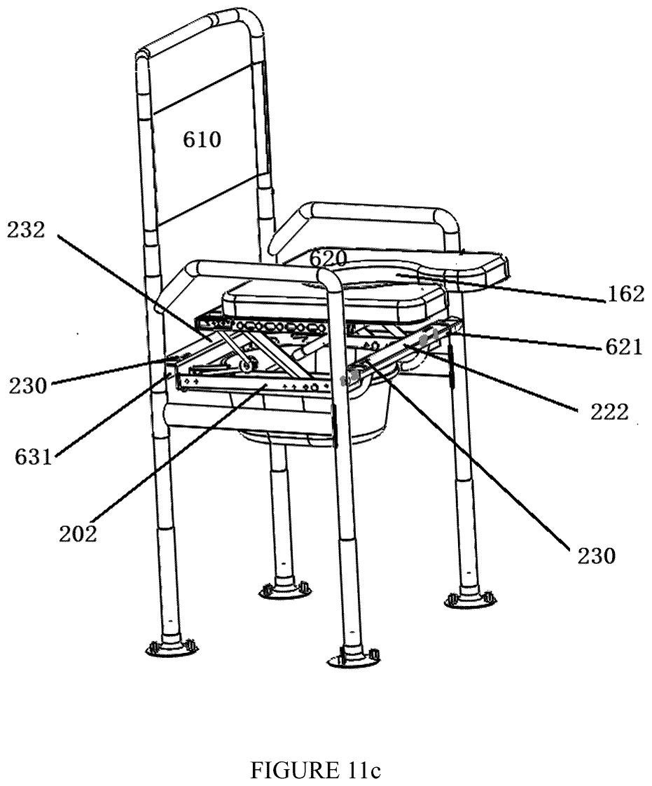

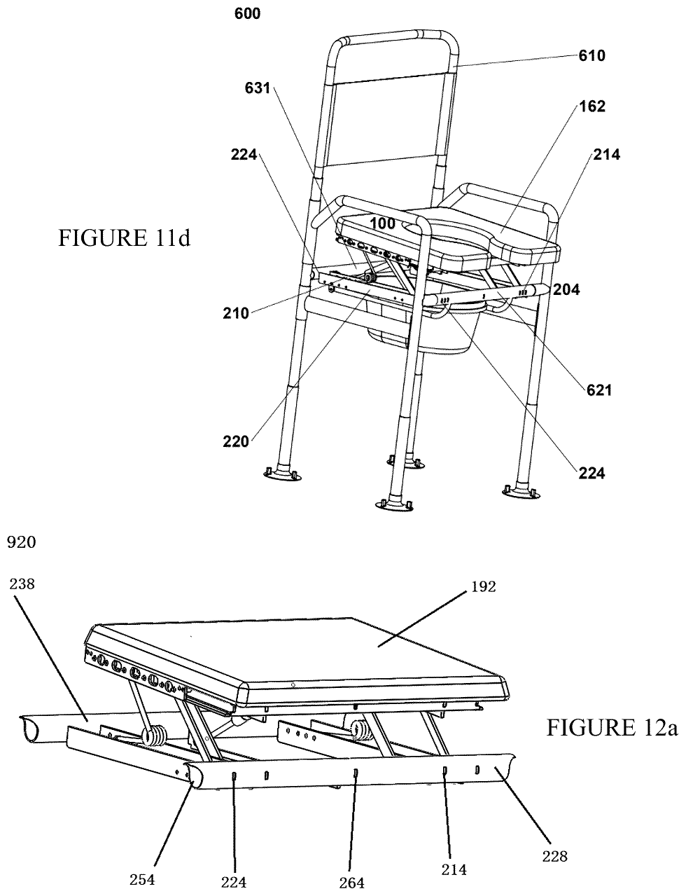

FIG. 11a is a perspective view of an exemplary sit-to-stand assist kit for a commode, in accordance with one or more embodiments. FIG. 11b is a perspective view of an exemplary commode frame. FIG. 11c is a perspective view of the sit-to-stand assist kit for commode of FIG. 11a implemented on the commode frame of FIG. 11b. FIG. 11d is a perspective view of the sit-to-stand device of FIG. 1 implemented on the commode frame of FIG. 11b. As shown in FIGS. 5d, 11b, and 11d, a third application of the disclosed sit-to-stand device is a sit-stand assist commode 600. The sit-to-stand assist commode 600 comprises a commode framework 610, the base 200, the slidable seat apparatus 100 with a commode seat surface 162, the lift apparatus 300, and the power apparatus 400. The commode seat surface 162 may comprise a toilet seat shape structure board covered with soft material for the comfort of user. The power apparatus 400 comprises two sets of gas springs 420 and wrap springs 410 on both sides along the width direction symmetrically. The side base brackets 220 and inner base brackets 210, and rod bracket 423 of the base 200 may be welded directly to the rear seat tube 631 and front seat tube 621 of the commode framework 610. The front base bracket 221 and rear base bracket 231 of the base 200 may be integrated to the commode framework 610, the disclosed sit-to-stand device is the integral part of the commode.

An alternative embodiment of the sit-to-stand assist commode 600 is to make a base with the front seat tube 621, rear seat tube 631, two side seat tubes of the commode framework 610, thereby substituting the front base bracket 221, rear base bracket 231 and two side base brackets 220 that form the rectangular base framework in previous embodiments described herein. The disclosed sit-to-stand device may be integrated to the commode by welding the inner base bracket 210 and the rod bracket 423 to the front seat tube 621 and rear seat tube 631 of the commode framework.

As shown in FIGS. 5c, 11a, and 11c, a commode can be converted to a sit-to-stand assist commode 600 by a sit-to-stand assist kit for commode 620 which comprises a outward flap base 202, the slidable seat apparatus 100 with a commode seat surface 162, the lift apparatus 300, and the power apparatus 400 with two wrap springs 410 and two gas springs 420 on both sides along the width direction symmetrically. The front base flap 222 and rear base flap 232 may be coupled (e.g., placed, mounted, secured, fixed, connected) onto the front seat tube 621 and rear seat tube 631 to convert the commode to the sit-to-stand assist commode 600 with the kit for commode 620. The punched flap slots 240 on the front base flap 222 and the rear base flap 232 may be used to secure the outward flap base 202 to the commode framework. The original commode seat surface 162 on the commode can be used as the seat surface of the sit-to-stand assist kit for commode 620. A latch can be used to lock the kit for commode 620 in a closed position.

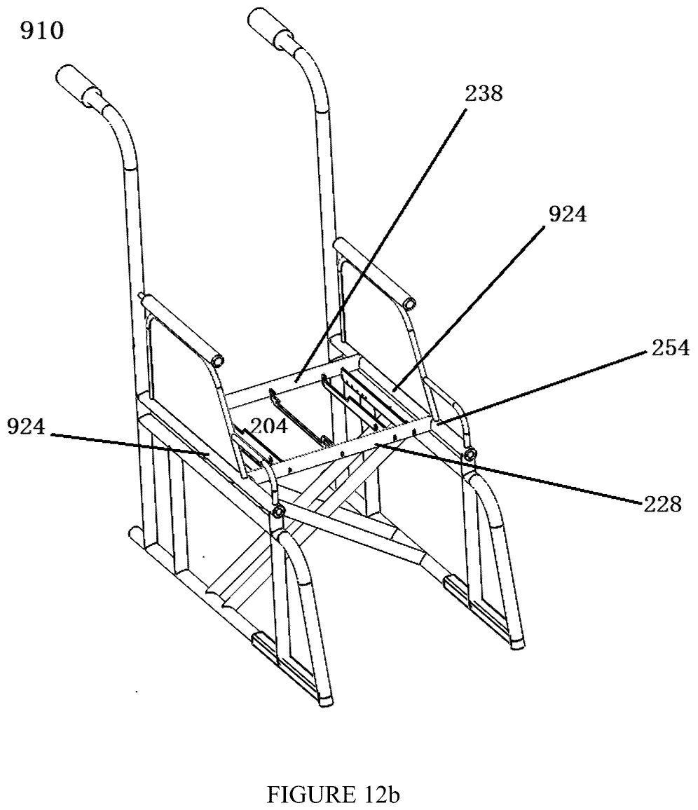

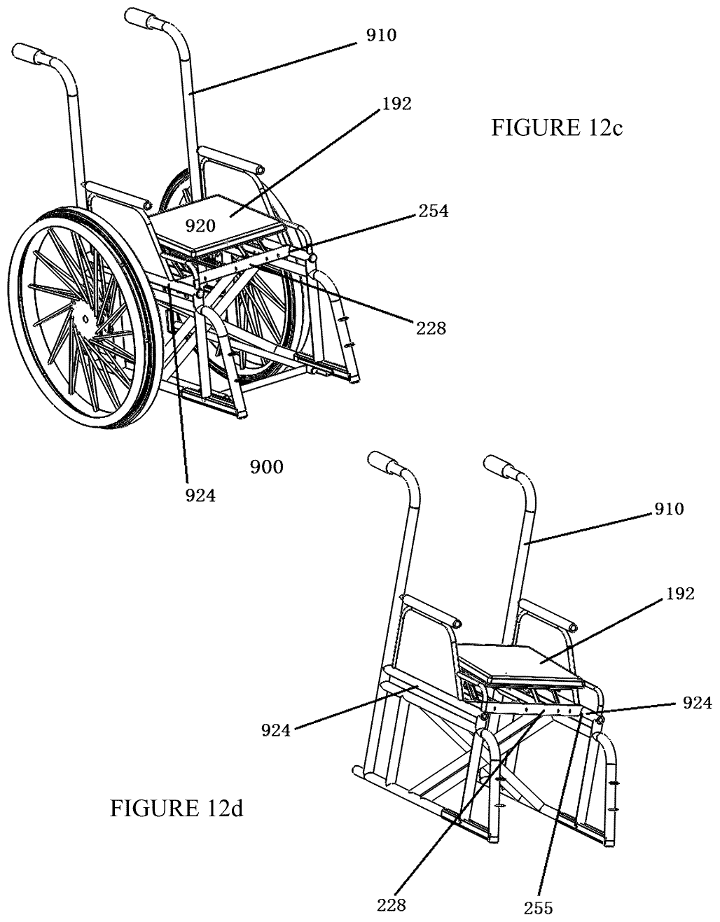

FIG. 12a is a perspective view of an exemplary sit-to-stand assist kit for a wheelchair, in accordance with one or more embodiments. FIG. 12b is a perspective view of an exemplary tube base implemented on a wheelchair frame, in accordance with one or more embodiments. FIG. 12c is a perspective view of the sit-to-stand assist kit for a wheelchair of FIG. 12a implemented on the wheelchair frame of FIG. 12b. FIG. 12d is a perspective view of an exemplary sit-to-stand device implemented on the wheelchair frame of FIG. 12b. As shown in FIGS. 5d, 12b and 12d, a fourth application of the disclosed sit-to-stand device is a sit-stand assist wheelchair 900. The sit-to-stand assist wheelchair 900 comprises a wheelchair framework 910, the base 200, the slidable seat apparatus 100, the lift apparatus 300, and the power apparatus 400. The slidable seat 110 of the slidable seat apparatus 100 comprises a seat surface 192 and slidable members 520, wherein the bottom part of the seat surface 192 features a steel structured flat board (e.g., 3 mm thick, or more or less depending on implementation) to support the seated weight of a user. Slidable members 520 may be positioned under the flat board (e.g., secured, coupled, fixed, mounted). The power apparatus 400 comprises two sets of gas springs 420 and wrap springs 410 on both sides along the width direction symmetrically. Both ends of the front base bracket 221 and rear base bracket 231 may be welded to the side seat tubes 924 of the wheelchair framework 910 to form an integrate sit-to-stand assist wheelchair 900.

An alternative implementation method of the sit-to-stand assist wheelchair 900 may comprise the side seat tubes 924 of the wheelchair framework 910, which may substitute the side base brackets 220, as previously described herein, to form a rectangular base framework with front base bracket 221 and rear base bracket 231. The sit-to-stand device may be integrated to the wheelchair by making the side base brackets 220 as an integral part of the side seat tubes 924 of the wheelchair framework.

As shown in FIGS. 5d, 12a and 12c, a wheelchair can be upgraded to a sit-stand assist wheelchair 900 by a sit-to-stand kit for wheelchair 920 which comprises a tube base 204, the slidable seat apparatus 100 with a wheelchair seat surface 192, the lift apparatus 300, and the power apparatus 400. Both ends of the rear base tube 238 and the front base tube 228 may comprise a quarter circle cut tube end 254 on both ends for easy mounting on side seat tubes 924 of the wheelchair framework 910. A latch can be used to lock the kit for wheelchair 920 in a closed position.

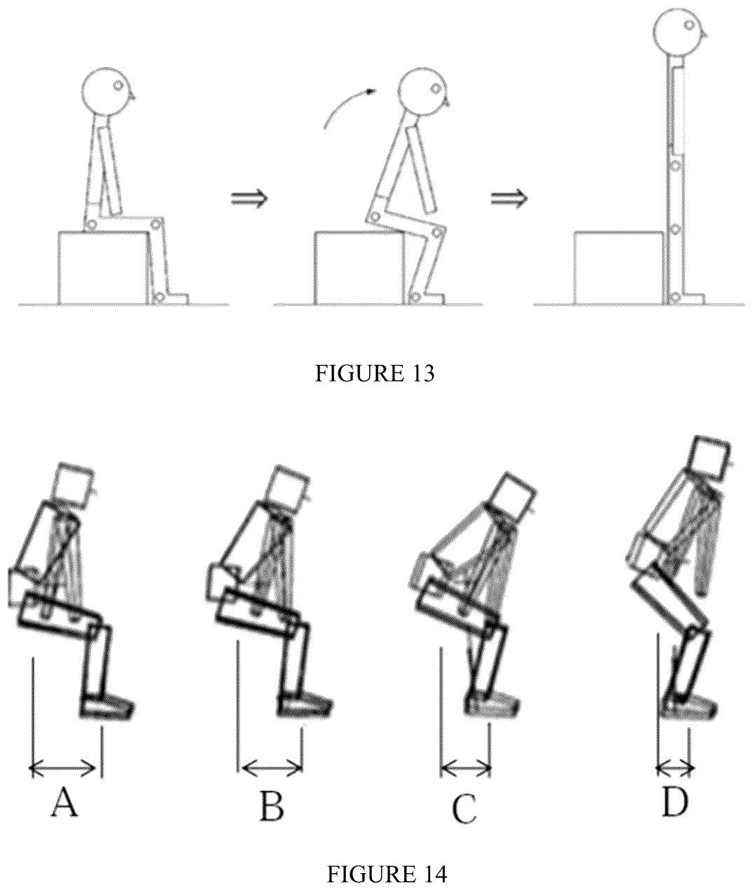

FIG. 13 is a series diagram illustrating phases of movement from sitting to standing, as described herein with respect to one or more embodiments. For example, when a user is seated in the disclosed sit-to-stand assist chair 800, the downward torque of a trunk weight of a seated user pushes down the slidable seat apparatus 100 and stores the seated potential energy into the power apparatus 400, the power apparatus 400 being contracted, the slidable seat apparatus 100 being lowered and resting on the outward flap base 202. When the chair is unseated (e.g., a user is not seated, partially or fully), the saved potential energy is released, the power apparatus 400 is extended, the slidable seat apparatus 100 is raised by the released energy, wherein the rear stanchion 320 sets the tilt angle of the raised slidable seat apparatus 100. In a first phase of the sit-to-stand transfer movements, the center of gravity of the seated trunk's weight moves forward by leaning a user's trunk forward and sliding forward a slidable seat (e.g., slidable seat 110), to reduce the downward torque on a stationary seat (e.g., stationary seat 112). Once the downward torque is decreased to less than the upward torque, the power apparatus 400 is triggered to release energy pushing the stationary seat 112 up and the sit-to-stand transfer movement advances to a second phase. In the second phase of the sit-to-stand transfer movements, the power apparatus 400 continuously release energy to raise the slidable seat apparatus 100 and assist a user to extend their legs and trunk until the phase two movement is complete. The muscle power reserved in the first phase of the sit-to-stand transfer movements can be used to stabilize and balance the rising trunk to reduce the risk of falls for the user in the second and third phases of the sit-to-stand transfer movements. This invention discloses a sit-to-stand device that utilizes sliding a seated trunk (e.g., a trunk or torso of a seated user) forward to reduce the trunk's weight torque on the seat, thereby triggering the power apparatus 400 to release energy to assist elderly and impaired individuals standing up from seated position.

FIG. 14 is a series diagram illustrating body suspension moment as a function of a degree of torso leaning and a degree of knee bending. Lengths A-D refer to a horizontal distance between a body's center of gravity and the body's feet on the ground. For example, length A represents the relative horizontal distance in a normal seated posture, length B represents the relative horizontal distance in a slightly forward position for a leaning body, length C represents the relative horizontal distance in a fully forward leaning body, and length D represents the relative horizontal distance in a standing or almost standing state.

All like-numbered or like-named elements are the same or similar to their corresponding elements in other figures described herein.

Those skilled in the art will understand that the structures and components described herein may comprise various materials suitable for jewelry (e.g., stainless steel, precious metals, metal alloys, other metals, plastic material, composite material, beads, crystal, natural and synthetic rubber material, gemstones, etc.), and that additional decorative patterns and materials may be etched, carved, attached, coupled, or otherwise added to the described structures and components.

Those skilled in the art will understand that the number, placement, shape, and surface texture of elements described herein may be varied and are not limited to the number(s), placement(s), shape(s), and texture(s) shown and described herein.

The foregoing describes various embodiments and those skilled in the art will appreciate that these embodiments may be used in combination with one or another as well as individually. Although the present disclosure has been illustrated and described herein with respect to a number of embodiments and examples, it will be readily apparent to those of ordinary skill in the art that other embodiments and examples may perform similar functions and/or achieve like results. All such equivalent embodiments and examples are within the spirit and scope of the present disclosure and are intended to be covered by the following claims.

What is claimed is:

1. A sit-to-stand apparatus comprising:
a base comprising a front base bracket, a rear base bracket, and two side base brackets, the base configured to be coupled to at least one of a chair, a bench, a wheelchair, a toilet seat, a commode, and an other seat type, where the front base bracket, the rear base bracket, and the two side base brackets together form a rectangular structure;
a slidable seat apparatus positioned above the base, the slidable seat apparatus comprising a slidable seat, at least two sliding mechanisms, and a stationary seat, wherein the slidable seat is configured to slide forward and backward, the at least two sliding mechanisms arranged beneath the slidable seat;
a lift apparatus configured to couple the base to the slidable seat apparatus, the lift apparatus comprising at least two sets of stanchions, each of the at least two sets of stanchions comprising a front stanchion and a rear stanchion, a first of the at least two sets of stanchions positioned toward a first side of the base and a second of the at least two sets of stanchions positioned toward a second side of the base; and
a power apparatus under the stationary seat, the power apparatus comprising at least two wrap springs and a gas spring, the power apparatus configured to release potential energy saved from a seated user to lift the seated user towards a standing position.

2. The apparatus of claim 1, wherein the power apparatus is configured to transfer a trunk weight of the seated user from the stationary seat to the base.

3. The apparatus of claim 1, wherein a first end of the front stanchion and another first end of the rear stanchion are each pivotally connected to a base bracket of the stationary seat.

4. The apparatus of claim 1, wherein a second end of the front stanchion and another second end of the rear stanchion are each pivotally connected to a seat bracket of the base.

5. The apparatus of claim 1, wherein the at least two sets of stanchions, the stationary seat, and the base together form a 3D quadrilateral structure.

6. The apparatus of claim 5, wherein pivoting the lift apparatus expands and contracts the 3D quadrilateral structure, thereby raising and lowering the stationary seat.

7. The apparatus of claim 1, wherein the base further comprises a front base flap and a rear base flap, wherein the front base flap and the rear base flap are configured to be coupled to a chair frame and/or a commode frame.

8. The apparatus of claim 1, wherein the base further comprises a front base bracket and a rear base bracket, wherein the front base bracket and the rear base bracket are configured to be coupled to a chair frame, a commode, and/or a wheelchair.

9. The apparatus of claim 1, wherein the base further comprises a front base tube and a rear base tube, one or both of the front base tube and the rear base tube comprising a quarter circle cut structure configured to couple to a wheelchair.

10. The apparatus of claim 1, wherein the base further comprises a front base tube and a rear base tube, one or both of the front base tube and the rear base tube comprising a full circle cut structure configured to fit to a tube frame, thereby integrating the sit-to-stand apparatus to a seat frame.

11. The apparatus of claim 1, wherein the base further comprises a front base flap and a rear base flap, the front base flap and the rear base flap configured to form a part of, or to be coupled to, a cushioned seat surface.

12. The apparatus of claim 1, wherein the sliding mechanism comprises a slidable member and a stationary member.

13. The apparatus of claim 12, wherein the slidable member comprises a roller bracket, a set screw, a plurality of roller shafts and a plurality of rollers.

14. The apparatus of claim 13, wherein the roller bracket comprises a metal bracket coupled to the bottom of the seat surface.

15. The apparatus of claim 13, wherein the set screw is arranged to a side of the roller bracket and configured to stop the roller bracket from exceeding its travel limit.

16. The apparatus of claim 13, wherein each of the plurality of rollers is fixed on one of the plurality of roller shafts.

17. The apparatus of claim 12, wherein the stationary member comprises a rail guide, a rail track, and a set screw.

18. The apparatus of claim 17, wherein the rail track comprises a long flat runway for a roller to roll on.

19. The apparatus of claim 17, wherein the rail guide is configured to confine a roller to travel linearly along a length of the stationary seat.

20. The apparatus of claim 17, wherein the rail guide and rail track form at least part of a U shape channel.

21. The apparatus of claim 12, further comprising a front limit and a rear limit, each configured to provide a front travel limit and a rear travel limit, respectively, to block the slidable member from moving beyond the front and rear travel limits.

22. The apparatus of claim 1, wherein the slidable seat comprises a seat surface for supporting a user's buttocks.

23. The apparatus of claim 1, wherein the stationary seat comprises a seat framework configured to support a seated trunk weight of a user, the seat framework comprising a front seat bracket, a rear seat bracket, and two side seat brackets that together form a rectangular structure.

24. The apparatus of claim 1, wherein each of the at least two wrap springs comprises a spring coil, an up spring arm, a low spring arm, an up spring arm end, and a low spring arm end, wherein the up spring arm extends from a first end of the spring coil and the low spring arm extends from a second end of the spring coil.

25. The apparatus of claim 24, wherein the up spring arm is coupled to the stationary seat and the low spring arm is coupled to the base.

26. The apparatus of claim 24, wherein the spring coil contracts when a downward pressure is applied to the slidable seat apparatus, thereby storing energy, and the spring coil releases stored energy to push the slidable seat apparatus up.

27. The apparatus of claim 1, wherein the gas spring comprises a cylinder, a rod, a rod end, and a cylinder end, wherein the rod aligns with the cylinder coaxially to form a sealed gas chamber containing a gas.

28. The apparatus of claim 27, wherein one of the rod end and the cylinder end is pivotally connected to the base.

29. The apparatus of claim 1, wherein the gas spring is configured to provide a damping effect to prevent the slidable seat apparatus from falling onto the base with excessive force when a user sits down on the slidable seat apparatus.

30. The apparatus of claim 1, wherein the power apparatus resides under the slidable seat apparatus, each of the at least two wrap springs between an inner bracket and an outer bracket, the gas spring between two inner brackets.

31. The apparatus of claim 1, wherein the at least two wrap springs and the gas spring reside within a cavity formed by the base and the slidable seat apparatus.
